(19) United States
(12) Patent Application Publication
(10) Pub. No.: US 2026/0319889 A1
(43) Pub. Date: Oct. 15, 2026

(54) MEMORY DEVICE WITH ERROR CORRECTION CODE DECODER CIRCUIT, MEMORY CONTROLLER WITH ERROR CORRECTION CODE CIRCUIT, AND METHOD OF OPERATING MEMORY DEVICE WITH ERROR CORRECTION CODE DECODER CIRCUIT

(71) Applicant: Samsung Electronics Co., Ltd., Suwon-si (KR)

(72) Inventors: Sangyun Kim, Suwon-si (KR); Hyunsuk Kang, Suwon-si (KR); Jindo Byun, Suwon-si (KR); Kyoungtae Kang, Suwon-si (KR); Dongku Kang, Suwon-si (KR); Youngdon Choi, Suwon-si (KR); Jiyoon Park, Suwon-si (KR); Seunghyeon Yun, Suwon-si (KR)

(21) Appl. No.: 19/560,928

(22) Filed: Mar. 9, 2026

(30) Foreign Application Priority Data
Apr. 14, 2025 (KR) 10-2025-0047930

(51) Int. Cl. G06F 11/10

(52) U.S. Cl. CPC G06F 11/1068; G06F 11/1048

(57) ABSTRACT

A memory device includes at least one first pin, a plurality of second pins, a memory interface circuit configured to obtain control information from at least one control signal received from the at least one first pin, obtain data from a plurality of data signals received from the plurality of second pins, and obtain a command and parity information from the control information by interpreting headers included in the control information, a memory cell array configured to store the data, an error correction code (ECC) decoder circuit configured to correct an error of the command based on using the parity information, to generate an error-corrected command, and a control circuit configured to control the memory device based on the error-corrected command in a reset state of a fail flag.

### CROSS-REFERENCE TO RELATED APPLICATIONS

This application claims the benefit under 35 USC 119(a) of an earlier filing date and right of priority to Korean Patent Application No. 10-2025-0047930 filed on Apr. 14, 2025 in the Korean Intellectual Property Office, the disclosure of which is incorporated herein by reference in its entirety.

### TECHNICAL FIELD

The present disclosure relates to a memory device, a memory controller controlling the memory device, and a method of operating the memory device.

### BACKGROUND

A memory device may transmit and receive input/output signals with a memory controller through predetermined pins. For example, the memory device may transmit and receive data with the memory controller through data input/output pins, and may transmit and receive control signals with the memory controller through control signal input/output pins that are different from the data input/output pins. When data and control signals are transmitted and received through different input/output pins, data may be transmitted at the same time as the control signal is transmitted, so that data transmission efficiency may be improved.

However, in order for data transmission efficiency to be further improved as the data transmission speed increases, the transmission speed of the control signal should also increase in accordance with the data transmission speed.

### SUMMARY

Example implementations provide a memory device, a memory controller, and a method of operating the memory device, in which a failure rate of a command may be reduced even as the transmission speed of a control signal increases.

According to example implementations, a memory device includes at least one first pin; a plurality of second pins; a memory interface circuit obtaining control information from at least one control signal received from the at least one first pin, obtaining data from a plurality of data signals received from the plurality of second pins, and obtaining a command and parity information from the control information by interpreting headers included in the control information; a memory cell array storing the data; an error correction code (ECC) decoder circuit correcting an error of the command, using the parity information, to generate an error-corrected command; and a control circuit controlling the memory device based on the error-corrected command in a reset state of a fail flag.

According to example implementations, a memory controller includes at least one first pin; a plurality of second pins; a processor configured to generate a command for controlling a memory device; a first error correction code (ECC) circuit configured to perform error correction encoding on the command to generate first parity information; and a controller interface circuit configured to provide at least one control signal including the command and the first parity to the memory device through the at least one first pin input and output data signals to and from the memory device through the plurality of second pins, receive a fail signal indicating failure of the at least one control signal from the memory device, and perform training on the at least one control signal based on the fail signal.

According to example implementations, a method of operating a memory device includes receiving at least one control signal including a command, an address, and parity information from a controller through at least one control signal line; performing error correction code (ECC) decoding of the command and the address using the parity information; setting a fail flag and generating failure information based on failure of an error correction of at least one of the command and the address; providing a response including the failure information through the at least one control signal line in response to a status read command from the controller and resetting the fail flag; and receiving a training command from the controller and providing a response through the at least one control signal line.

### BRIEF DESCRIPTION OF DRAWINGS

The above and other aspects, features, and advantages of the present disclosure will be more clearly understood from the following detailed description, taken in conjunction with the accompanying drawings.

FIG. 1 is a diagram illustrating an example of a memory system according to some implementations.

FIG. 2 is a timing diagram of a control signal and a data signal.

FIG. 3 is a diagram illustrating an example of a memory system according to some implementations.

FIG. 4 is a diagram illustrating an example of a memory device according to some implementations.

FIG. 5 is a flow chart illustrating an example of operation of a memory device according to some implementations.

FIG. 6 is a timing diagram of an example control signal according to some implementations.

FIG. 7 is a timing diagram of an example control signal and an example fail flag signal according to some implementations.

FIG. 8 is a flow chart illustrating an example of the operation of a memory device according to some implementations.

FIG. 9 is a timing diagram of an example of a control signal and an example of a fail flag signal according to some implementations.

FIG. 10 is a diagram illustrating an example interaction of a memory controller and a memory device according to some implementations.

### DETAILED DESCRIPTION

Hereinafter, example implementations will be described with reference to the accompanying drawings.

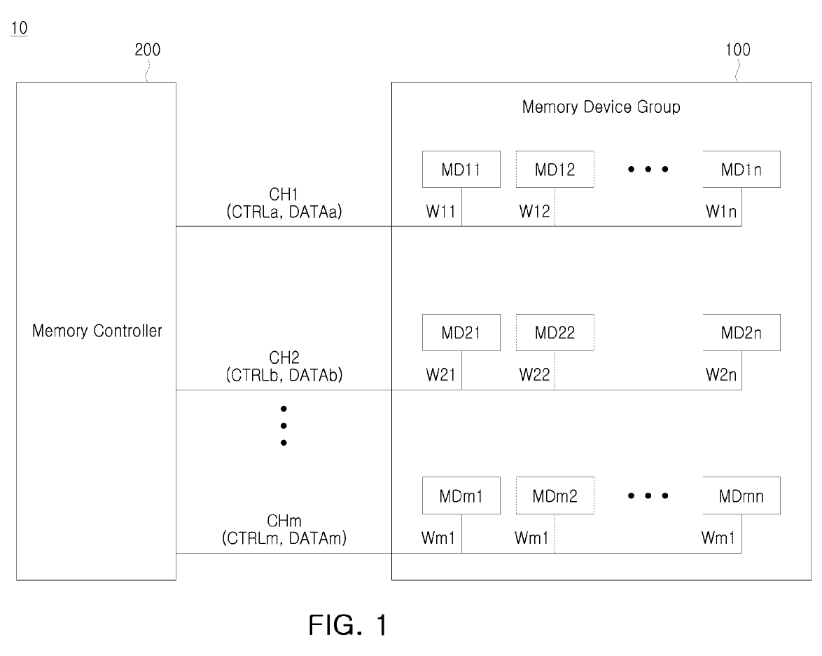

FIG. 1 is a diagram illustrating a memory system according to some example implementations.

Referring to FIG. 1, a memory system 10 may include a memory device group 100 and a memory controller 200. The memory system 10 may support a plurality of channels CH1-CHm, and the memory device group 100 and the memory controller 200 may be connected through the plurality of channels CH1-CHm. For example, the memory system 10 may be implemented as a memory system such as a Solid State Drive (SSD).

The memory device group 100 may include a plurality of memory devices MD11-MDmn. Each of the plurality of memory devices MD11-MDmn may be a flash memory device. However, the present disclosure is not limited thereto, and each of the plurality of memory devices MD11-MDmn may include a nonvolatile memory such as Resistive Random Access Memory (RRAM), Ferroelectric Random Access Memory (FRAM), Phase Change Random Access Memory (PRAM), Thyristor Random Access Memory (TRAM), or Magnetic Random Access Memory (MRAM), or a volatile memory such as Dynamic Random Access Memory (DRAM) or Static Random Access Memory (SRAM).

Each of the memory devices MD11-MDmn may be connected to one of the plurality of channels CH1-CHm through a corresponding way. For example, the memory devices MD11-MD1n may be connected to the first channel CH1 through the ways W11-W1n, and the memory devices MD21-MD2n may be connected to the second channel CH2 through the ways W21-W2n. In some example implementations, each of the memory devices MD11-MDmn may be implemented as an arbitrary memory unit that may operate according to an individual control signal from the memory controller 200. For example, each of the memory devices MD11-MDmn may be implemented as a chip or a die, but the present disclosure is not limited thereto.

The memory controller 200 may transmit and receive signals with the memory device group 100 through a plurality of channels CH1-CHm. For example, the memory controller 200 may transmit control signals CTRLa-CTRLm and data signals to the memory device group 100 through the channels CH1-CHm, and receive data signals DATAa-DATAm from the memory device group 100. The control signal may include a command and may further include an address.

The memory controller 200 may select one of the memory devices connected to the corresponding channel through each channel, and transmit and receive signals with the selected memory device. For example, the memory controller 200 may select the memory device MD11 among the memory devices MD11-MD1n connected to the first channel CH1. The memory controller 200 may transmit a control signal CTRLa and a data signal DATAa to the selected memory device MD11 through the first channel CH1, and receive data DATAa from the selected memory device MD11.

The memory controller 200 may transmit and receive signals in parallel with the memory device group 100 through different channels. For example, the memory controller 200 may transmit a control signal CTRLa to the memory device group 100 through the first channel CH1 while transmitting a control signal CTRLb to the memory device group 100 through the second channel CH2. For example, the memory controller 200 may receive a data signal DATAa from the memory device group 100 through the first channel CH1 while receiving a data signal DATAb from the memory device group 100 through the second channel CH2.

The memory controller 200 may control the overall operation of the memory device group 100. The memory controller 200 may control the respective memory devices MD11-MDmn connected to the channels CH1-CHm by transmitting signals to the channels CH1-CHm. For example, the memory controller 200 may control a selected one of the memory devices MD11-MD1n by transmitting a control signal CTRLa to the first channel CH1.

Each of the memory devices MD11-MDmn may operate under the control of the memory controller 200. For example, the memory device MD11 may program data according to a control signal CTRLa provided to the first channel CH1 and a data signal DATAa. For example, the memory device MD21 may read data according to a control signal CTRLb provided to the second channel CH2 and transmit the read data as a data signal DATAb to the memory controller 200.

In FIG. 1, the memory device group 100 is illustrated as communicating with the memory controller 200 through M channels, and the memory device group 100 includes N nonvolatile memory devices corresponding to respective channels. However, the number of channels and the number of nonvolatile memory devices connected to one channel may be changed in various manners.

One channel may include a control signal line for transmitting and receiving a control signal and a data signal line for transmitting and receiving a data signal. Control signals and data signals may be transmitted and received in parallel through the control signal line and the data signal line.

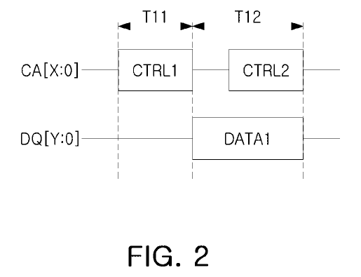

FIG. 2 is a timing diagram of the control signal and the data signal.

The memory controller 200 and the memory device MD (MD11-MDmn) described with reference to FIG. 1 may transmit and receive one or more control signals CA[X:0] through one or more control signal lines and may transmit and receive multiple data signals DQ[Y:0] through multiple data lines.

For example, the memory controller 200 and the memory device MD may transmit and receive control signals CA[1:0] through two control signal lines and data signals DQ[7:0] through eight data pins. Hereinafter, some example implementations will be described by taking as an example a case where multiple control signals are transmitted and received between the memory controller 200 and the memory device MD. However, the present disclosure does not exclude the case where one control signal is transmitted and received through one control signal line, or the case where one data signal is transmitted and received through one data line, between the memory controller 200 and the memory device MD.

The memory device MD may receive control signals CA[X:0] in the first period T11 and obtain first control information CTRL1 from the control signals CA[X:0]. For example, the first control information CTRL1 may include a command and an address. The memory device MD may obtain first data DATA1 from data signals DQ[Y:0] or output the first data DATA1 stored in the memory device MD as the data signals DQ[Y:0], based on the first control information CTRL1 obtained in the first period T11.

For example, when the command is a program command, the memory device MD may obtain the first data DATA1 in the second period T12, and in the case in which the command is a read command, the memory device MD may output the first data DATA1 in the second period T12.

The memory device MD may receive the control signals CA[X:0] in the second period T12, and obtain the second control information CTRL2 from the control signals CA[X:0]. For example, the memory device MD may obtain the second control information CTRL2 through the control signal lines that are distinct from the data signal lines at the same time as the first data DATA1 is input/output. Since the input/output paths of the data and the control information are different, the memory device MD may input/output the data at the same time as obtaining the control information, and the data input/output efficiency may be improved.

To further improve data input/output efficiency, the reception speed of control information may also need to increase in response to the increasing data input/output speed. The size of the control information may be smaller than the size of the data, and the reception speed of the control information may be slower than the data input/output speed. For example, to prevent malfunction of the memory device MD, the control information may require a higher level of integrity than the data. Therefore, the memory controller 200 may provide sufficient timing margin for sampling the control signals by transmitting control signals having a lower frequency than the frequency of the data signals.

However, if the period for receiving the control signals including the second control information CTRL2 is longer than the period for inputting/outputting the data signals including the first data DATA1, the data signals based on the second control information CTRL2 may not be input/output until the reception of the control signals is completed even after the reception of the first data DATA1 is completed. Therefore, the data input/output efficiency may be reduced.

If the frequency of control signals is increased to improve data input/output efficiency, the timing margin may be reduced and the failure rate of the command or address included in the control information may increase. The fail of the command or address may refer to a state in which the command cannot be normally executed because the received command or address includes an error bit. If the failure rate increases, the possibility of malfunction of the memory device MD may increase.

According to some example implementations, the control information may further include not only the command and the address, but also the parity (e.g., parity information) of the command and the address. The memory device may receive control signals CA[X:0] including the parity through a control signal line. The memory device may obtain the command, the address, and the parity from the control signals CA[X:0], and may detect and correct errors of the command and the address using the parity, thereby reducing the failure rate.

In addition, the memory device may prevent malfunction by setting a fail flag and ignoring the control information when an error of the control information is not corrected. When the fail flag is set, the memory device may output failure information through the control line in response to a status read command received through the control line.

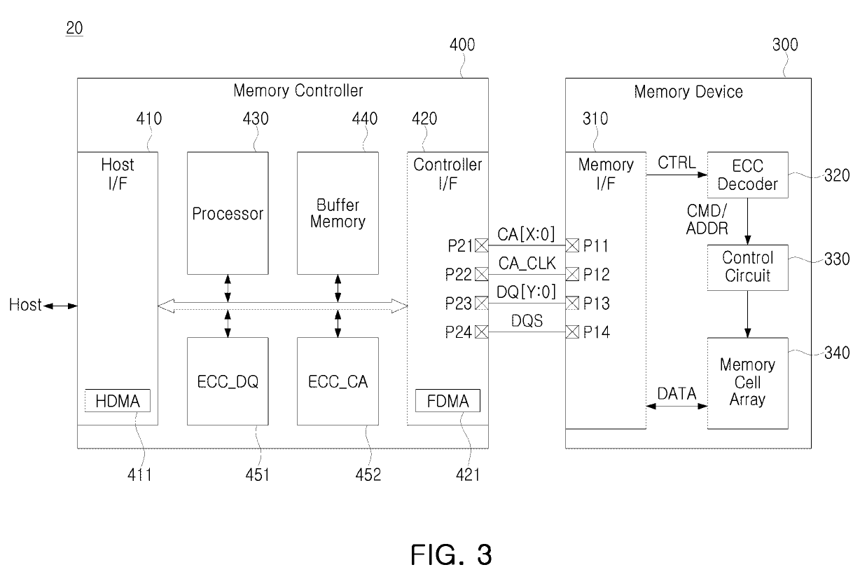

Hereinafter, a memory system including a memory device according to some example implementations will be described in detail with reference to FIGS. 3-10.

FIG. 3 is a drawing illustrating a memory system according to some example implementations.

Referring to FIG. 3, the memory system 20 may include a memory device 300 and a memory controller 400. The memory device 300 may correspond to any one of the memory devices MD (MD11-MDmn) described with reference to FIG. 1, and the memory controller 400 may correspond to the memory controller 200 described with reference to FIG. 1.

The memory device 300 may include first to fourth pins P11 to P14, a memory interface circuit 310, an ECC decoder circuit 320, a control logic circuit 330, and a memory cell array 340.

The memory interface circuit 310 may transmit and receive one or more control signals CA[X:0], a control clock signal CA_CLK, a plurality of data signals DQ[Y:0], and a data strobe signal DQS through the first to fourth pins P11 to P14.

In detail, the memory interface circuit 310 may obtain control information from the control signals CA[X:0] received through the first pins P11. The number of the first pins P11 may be equal to the number of the control signals.

According to some example implementations, the control information may include at least a command and a parity, and may further include an address. For example, when the control information includes a command, an address, and a parity, the parity may include a first parity obtained by performing error correction encoding on the command, and a second parity obtained by performing error correction encoding on the address. However, the present disclosure is not limited thereto, and the parity may be a parity obtained by performing error correction encoding on the entire command and address.

The memory interface circuit 310 may obtain the control information by sampling the control signals CA[X:0] based on the control clock signal CA_CLK received through the second pin P12. The control clock signal CA_CLK may maintain a static state, such as a high level or a low level, during a period in which the control signals CA[X:0] are not received, and may toggle between the high level and the low level during a period in which the control signals CA[X:0] are received.

In addition, the memory interface circuit 310 may transmit control signals CA[X:0] including control information, such as a response to a status read command, to the memory controller 400. The memory interface circuit 310 may generate a control clock signal CA_CLK and transmit control signals CA[X:0] to the memory controller 400 based on the generated control clock signal CA_CLK.

The memory interface circuit 310 may obtain data DATA from data signals DQ[Y:0] received through the third pins P13 or generate data signals DQ[Y:0] including data DATA. The number of the third pins P13 may be the same as the number of data signals DQ[Y:0].

The memory interface circuit 310 may obtain data DATA from data signals DQ[Y:0] through a data strobe signal DQS received from the memory controller 400 through the fourth pin P14. In addition, the memory interface circuit 310 may generate a data strobe signal DQS and transmit third signals SIG3 including data DATA to the memory controller 400 based on the generated data strobe signal DQS.

In some example implementations, the frequency of the data signals DQ[Y:0] and the data strobe signal DQS may be higher than the frequency of the control signals CA[X:0] and the control clock signal CA_CLK.

The ECC decoder circuit 320 may perform error detection and correction of the control information CTRL obtained from the memory interface circuit 310. The ECC decoder circuit 320 may correct errors in commands and addresses included in the control information CTRL by performing error correction decoding using parity included in the control information CTRL, and output a command/address CMD/ADDR with corrected errors.

According to some example implementations, the control information CTRL received from the memory controller 400 may include parity, and the ECC decoder circuit 320 may correct errors in the command and address using the parity.

The control logic circuit 330 may control the overall operation of the memory device 300. The control logic circuit 330 may receive a command/address CMD/ADDR from the ECC decoder circuit 320. The control logic circuit 330 may generate internal signals for controlling other components of the memory device 300 according to the received command/address CMD/ADDR. For example, the control logic circuit 330 may generate various internal signals for programming data DATA into the memory cell array 340 or reading data DATA from the memory cell array 340.

According to some example implementations, if the ECC decoder circuit 320 fails to correct at least some of the errors in the command and address, the control logic circuit 330 may set a fail flag. The control logic circuit 330 may ignore the command/address CMD/ADDR received after the fail flag is set, except for the status read command.

The control logic circuit 330 may provide failure information to the memory controller 400 in response to the status read command while the fail flag is set, and reset the fail flag. According to some example implementations, the failure information may be transmitted through the first pin P11.

The memory cell array 340 may store data DATA obtained from the memory interface circuit 310 under the control of the control logic circuit 330. The memory cell array 340 may output stored data DATA to the memory interface circuit 310 under the control of the control logic circuit 330.

The memory cell array 340 may include a plurality of memory cells. For example, the plurality of memory cells may be flash memory cells. However, the present disclosure is not limited thereto, and the memory cells may be non-volatile memory cells or volatile memory cells. Hereinafter, implementations will be described based on some example implementations in which the memory cells are NAND flash memory cells.

The memory controller 400 may include first to fourth pins P21 to P24, a host interface circuit 410, a controller interface circuit 420, a processor 430, a buffer memory 440, a data ECC circuit 451, and a control ECC circuit 452.

The host interface circuit 410 may transmit and receive packets with the host. A packet transmitted from the host to the host interface circuit 410 may include a command or data to be written to the memory device 300, and a packet transmitted from the host interface circuit 410 to the host may include a response to the command or data read from the memory device 300.

The first to fourth pins P21 to P24 may correspond to the first to fourth pins P11 to P14 of the memory device 300. The first pins P11 and the first pins P21 may be connected through control signal lines, and the second pin P12 and the second pin P22 may be connected through a control clock signal line. The third pins P13 and the third pins P23 may be connected through data signal lines, and the fourth pin P14 and the fourth pin P24 may be connected through a data strobe signal line.

The controller interface circuit 420 may transmit and receive control signals CA[X:0], a control clock signal CA_CLK to and from the memory device 300 through the first to fourth pins P21 to P24, and may transmit and receive data signals DQ[Y:0] and a data strobe signal DQS to and from the memory device 300.

In detail, the controller interface circuit 420 may transmit control signals CA[X:0] through the first pins P21, and transmit a control clock signal CA_CLK for sampling the control signals CA[X:0] through the second pin P22. Alternatively, the controller interface circuit 420 may receive control signals CA[X:0] through the first pins P21, and receive a control clock signal CA_CLK through the second pin P22.

And, the controller interface circuit 420 may transmit data signals DQ[Y:0] through the third pins P23 and transmit a data strobe signal DQS for sampling the data signals DQ[Y:0] through the fourth pin P24. Alternatively, the controller interface circuit 420 may receive data signals DQ[Y:0] through the third pins P23 and receive a data strobe signal DQS through the fourth pin P24.

The processor 430 may control the overall operation of the memory controller 400 by executing firmware such as Flash Translation Layer (FTL). For example, the processor 430 may perform various functions such as address mapping, wear-leveling, and garbage collection.

The processor 430 may generate commands and addresses to control the memory device 300. For example, the processor 430 may generate commands such as a program command, a read command, and an erase command, and addresses corresponding to memory areas where the commands are to be performed. In addition, the processor 430 may generate a status read command to request the status of the memory device 300.

The buffer memory 440 may store data to be programmed into the memory device 300, data read from the memory device 300, and meta data such as map data. The buffer memory 440 may be provided within the memory controller 400, but may also be disposed outside the memory controller 400.

The data ECC circuit 451 may perform an error detection and correction function for data read from the memory device 300. In detail, the data ECC circuit 451 may generate parity for program data to be programmed in the memory device 300. The generated parity may be stored in the memory device 300 together with the program data. In addition, the data ECC circuit 451 may correct an error in the read data using the parity read from the memory device 300 together with the read data, and output the read data with the error corrected.

The control ECC circuit 452 may generate parity for a command and an address transmitted to the memory device 300. As a first example, the control ECC circuit 452 may generate a parity including a first parity for the command and a second parity for the address. As a second example, the control ECC circuit 452 may generate one parity by performing error correction encoding for the command and the address.

In some example implementations, different error correction codes may be applied to the data ECC circuit 451 and the control ECC circuit 452. For example, the size of the data may be larger than the size of the command and the size of the address. Therefore, the error correction code applied to the data ECC circuit 451 may support error correction encoding for a codeword of a larger size than the error correction code applied to the control ECC circuit 452.

In some example implementations, the host interface circuit 410 may include a Host Direct Memory Access (HDMA) 411 that controls data transmission and reception between the host memory and the buffer memory 440. In addition, the controller interface circuit 420 may include a Flash Direct Memory Access (FDMA) 421 that controls data transmission and reception between the buffer memory 440 and the memory interface circuit 310. The HDMA 411 and the FDMA 421 may transmit data without intervention of the processor 430.

According to some example implementations, the memory controller 400 may protect the command and address from errors and reduce the failure rate of the control signal by transmitting a control signal with parity added to the command and address to the memory device 300. In response to the trend of high-speed data input/output, even if the transmission speed of the control signal is high-speed, the failure rate of the control signal may be reduced. As a result, the data input/output efficiency may be improved.

In addition, the memory controller 400 may retransmit a control signal including a failed command or address in response to failed data from the memory device 300. In some example implementations, the memory controller 400 may lower the frequency of the control signal to increase the timing margin of the control signal, and may also perform a recovery operation of re-training the control signal line. Therefore, the reliability of the memory system 20 may be improved.

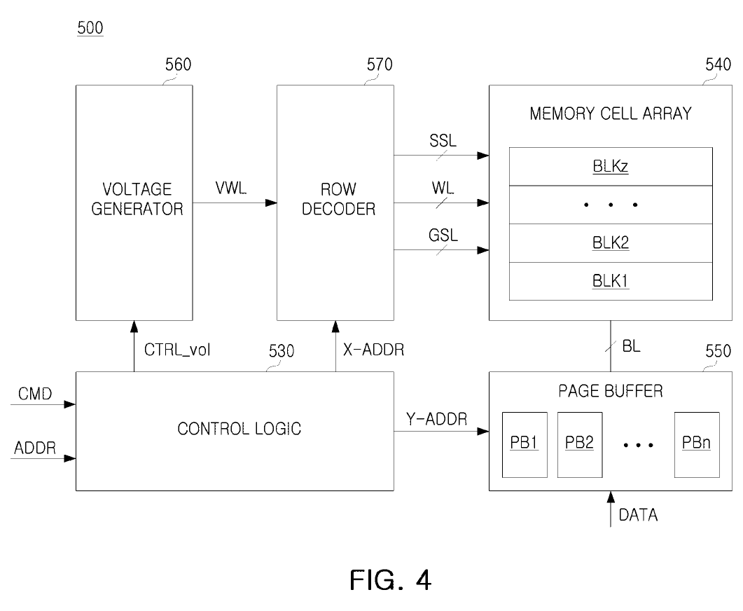

Hereinafter, before the operation of the memory system according to the example implementations is described in detail, the structure of the memory device is described in more detail with reference to FIG. 4.

FIG. 4 is a drawing illustrating a memory device according to the example implementations.

FIG. 4 is an example block diagram illustrating a nonvolatile memory device. Referring to FIG. 4, a nonvolatile memory 500 may include a control logic circuit 530, a memory cell array 540, a page buffer 550, a voltage generator 560, and a row decoder 570. Although not illustrated in FIG. 4, the nonvolatile memory 500 may further include circuits such as the memory interface circuit 310 and the ECC decoder circuit 320 described with reference to FIG. 3, and may further include a column logic, a pre-decoder, a temperature sensor, a command decoder, an address decoder, and the like.

The control logic circuit 530 may control various operations within the nonvolatile memory 500 in general. The control logic circuit 530 may output various internal signals in response to a command CMD and/or an address ADDR received by the memory interface circuit and corrected by the ECC decoder circuit. For example, the control logic circuit 530 may output a voltage control signal CTRL_vol, a row address X-ADDR, and a column address Y-ADDR.

The memory cell array 540 may include a plurality of memory blocks BLK1 to BLKz (z is a positive integer), and each of the plurality of memory blocks BLK1 to BLKz may include a plurality of memory cells. The memory cell array 540 may be connected to the page buffer 550 via bit lines BL and may be connected to the row decoder 570 via word lines WL, string select lines SSL, and ground select lines GSL.

In some example implementations, the memory cell array 540 may include a three-dimensional memory cell array, and the three-dimensional memory cell array may include a plurality of NAND strings. Each NAND string may include memory cells respectively connected to word lines vertically stacked on the substrate. Examples of the memory cell array 540, when implemented as a three-dimensional memory cell array, are described in U.S. Patent Publication No. 7,679,133, U.S. Patent Publication No. 8,553,466, U.S. Patent Publication No. 8,654,587, U.S. Patent Publication No. 8,559,235, and U.S. Patent Application Publication No. 2011/0233648, the contents of which are incorporated herein by reference in their entirety. In some example implementations, the memory cell array 540 may include a two-dimensional memory cell array, and the two-dimensional memory cell array may include a plurality of NAND strings disposed along the row and column directions.

The page buffer 550 may include a plurality of page buffers PB1-PBn (n is an integer of 3 or more), and the plurality of page buffers PB1-PBn may be respectively connected to the memory cells via a plurality of bit lines BL. The page buffer 550 may select at least one bit line among the bit lines BL in response to the column address Y-ADDR. The page buffer 550 may operate as a write driver or a sense amplifier depending on the operation mode. For example, during a program operation, the page buffer 550 may apply a bit line voltage corresponding to data to be programmed to the selected bit line. During a read operation, the page buffer 550 may detect data stored in the memory cell by detecting the current or voltage of the selected bit line.

The voltage generator 560 may generate various types of voltages for performing program, read, and erase operations based on the voltage control signal CTRL_vol. For example, the voltage generator 560 may generate a program voltage, a read voltage, a program verification voltage, an erase voltage, and the like as the word line voltage VWL.

The row decoder 570 may select one of a plurality of word lines WL and one of a plurality of string select lines SSL in response to a row address X-ADDR. For example, during a program operation, the row decoder 570 may apply a program voltage and a program verification voltage to the selected word line, and during a read operation, the row decoder 570 may apply a read voltage to the selected word line.

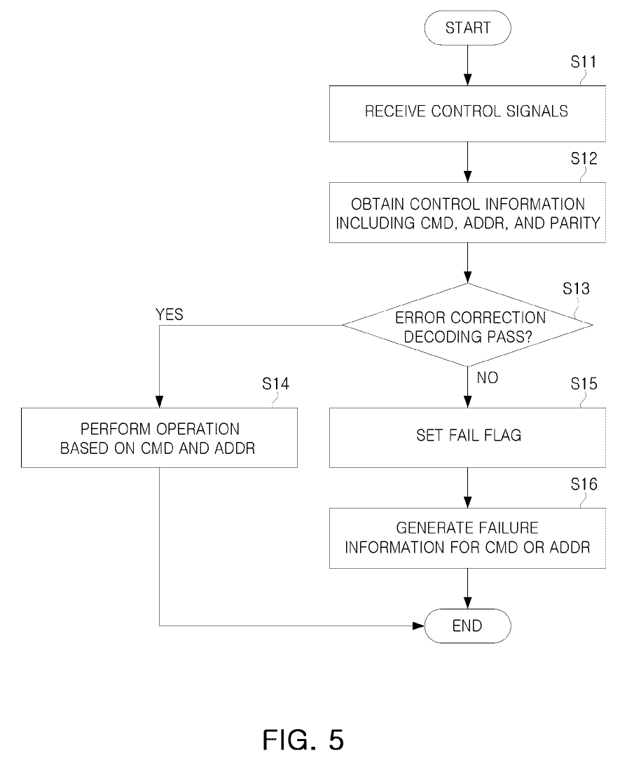

Hereinafter, with reference to FIGS. 5-9, the operation of a memory device according to some example implementations is specifically described.

FIG. 5 is a flowchart illustrating the operation of a memory device according to some example implementations.

In operation S11, a memory device, for example, a memory interface circuit 310 of FIG. 3, may receive control signals CA[X:0] from a memory controller. As described with reference to FIG. 3, the memory device may receive a control clock signal CA_CLK together with the control signals CA[X:0].

In operation S12, the memory interface circuit 310 may obtain control information including a command CMD, an address ADDR, and parity. For example, the memory device may obtain control information including a plurality of bits by sampling the control signals CA[X:0] with the control clock signal CA_CLK.

Meanwhile, the control information may not necessarily include an address. For example, the status read command may not require an address. Therefore, the memory device may obtain control information including only a command CMD and parity.

In operation S13, the memory device, for example, the ECC decoder circuit 320 of FIG. 3, may perform error correction decoding on the command and address and determine whether the error correction decoding passes.

If the error correction decoding passes (“Yes” in operation S13), the memory device, for example, the control circuit 330 of FIG. 3, may perform an operation based on the error-corrected command CMD and the error-corrected address ADDR in operation S14.

If the error correction decoding fails (“No” in operation S13), the control circuit 330 may set a fail flag in operation S15. In detail, the control circuit 330 may set a fail flag even if error correction decoding of either the command CMD or the address ADDR fails.

In operation S16, the control circuit 330 may generate failure information for the command CMD or the address ADDR. In some example implementations, the failure information may indicate which control information has failed. In addition, when the parity includes parities for the respective command CMD and address ADDR, the failure information may include information indicating whether error correction decoding of the command CMD has failed or error correction decoding of the address ADDR has failed.

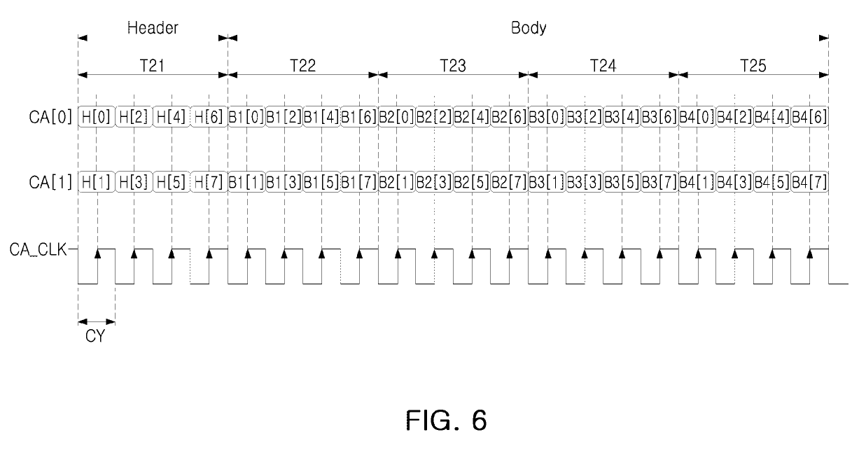

Below, before the signal timing of the control signal and the fail flag is described, a transmission method of the control signal is described with reference to FIG. 6 in detail.

FIG. 6 is a timing diagram of a control signal according to some example implementations.

In an example of FIG. 6, a transmission method of control signals is described by taking a case where control information is received through two control signals CA[1:0] by way of example.

The memory device may receive the control signals CA[1:0] in parallel. While the control signals CA[1:0] are received, the memory device may receive a toggling control clock signal CA_CLK. The memory device may obtain control information from the control signals CA[1:0] based on the control clock signal CA_CLK.

For example, the memory device may obtain two bits in one cycle CY of the control clock signal CA_CLK by sampling the control signals CA[1:0] at the rising edge of the control clock signal CA_CLK. The memory device may obtain a control signal including a plurality of bits over a plurality of unit periods T21-T25.

The period during which the control signal is received may be divided into a plurality of unit periods T21-T25. The unit period may correspond to one or more cycles CY of the control clock signal CA_CLK. In the example of FIG. 6, the unit period may correspond to four cycles of the control clock signal CA_CLK. The memory device may obtain an 8-bit signal from the control signals CA[1:0] received in the unit period. However, the number of control signals received in parallel and the number of cycles CY included in one period are not limited thereto.

The memory device may obtain a command, an address, and a parity from the control signal received in the plurality of unit periods. The control signal may include a header and a body following the header. The body may be any one of a command, an address, and a parity. The header may include information indicating whether the body is a command, an address, or a parity.

In the example of FIG. 6, a header may be received in the first period T21. For example, the header may include header bits (H[7:0]) received in the first period T21. The header may indicate whether control signals CA[1:0] received in unit periods after the first period T21 are commands, addresses, or parity. However, the length of the header is not limited to 8 bits.

A body received in the second to fifth periods T22-T25 may include a command, an address, or parity. For example, the body may include body bits (B1[7:0], B2[7:0], B3[7:0] and B4[7:0]) received in the second to fifth periods T22-T25.

In some example implementations, the magnitudes of the command, address, and parity may be different from each other. The memory device may obtain a command, address, or parity from control signals CA[1:0] received in a number of unit periods determined based on the header.

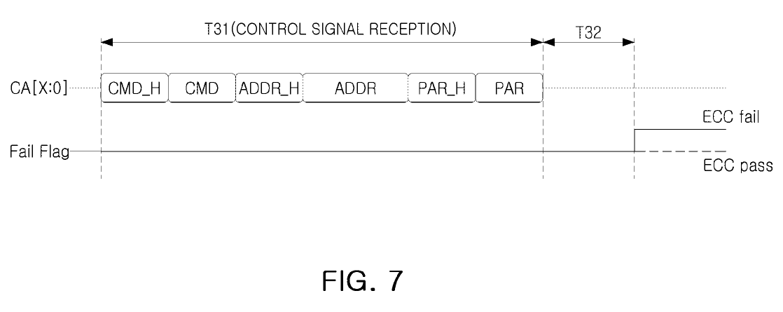

FIG. 7 is a timing diagram of a control signal and a fail flag signal according to some example implementations.

Referring to FIG. 7, the memory device may receive control signals CA[X:0] and generate a fail flag. The fail flag may be maintained in a reset state before a fail of the control signal is detected, and may be set when a fail of the control signal is detected.

In detail, the memory device may receive control signals CA[X:0] in a first period T31. For example, the control signals CA[X:0] received in the period may include a command header CMD_H, a command CMD, an address header ADDR_H, an address ADDR, a parity header PAR_H, and a parity PAR.

The memory device may perform error correction of the command and address in the second period T32. For example, the memory interface circuit 310 described with reference to FIG. 3 may obtain the command CMD, the address ADDR, and the parity PAR based on the headers CMD_H, ADD_H and PAR_H of the control signals CA[X:0]. In addition, the ECC decoder circuit 320 described with reference to FIG. 3 may perform error correction of the command CMD and the address ADDR based on the parity PAR.

The fail flag may maintain a reset state in the first and second periods T31 and T32. If the error correction of the command and address passes (ECC pass), the fail flag may maintain a reset state even after the second period T32. However, if the error correction of the command or address fails (ECC fail), the memory device may set the fail flag after the second period T32.

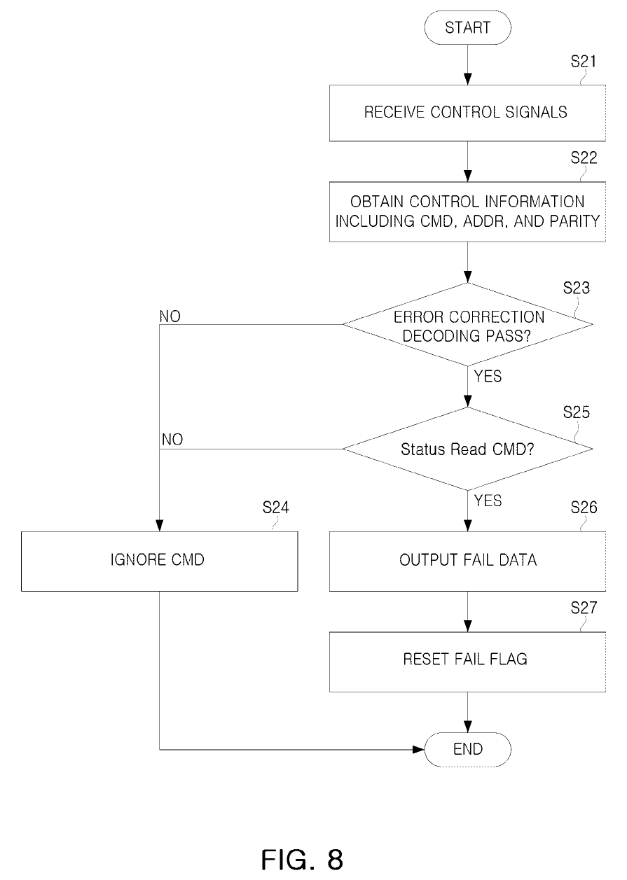

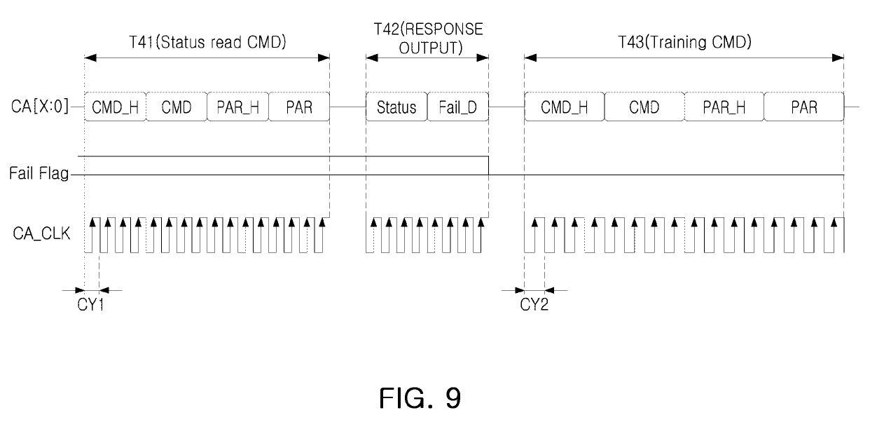

Hereinafter, with reference to FIGS. 8 and 9, the operation of the memory device in a state where the fail flag is set will be described in detail.

FIG. 8 is a flowchart illustrating the operation of the memory device according to some example implementations.

In operation S21, the memory device, for example, the memory interface circuit 310 described with reference to FIG. 3, may receive control signals CA[X:0] from the memory controller.

In operation S22, the memory interface circuit 310 may obtain control information including a command CMD, an address ADDR, and parity. For example, the memory interface circuit 310 may obtain control information including a plurality of bits by sampling the control signals CA[X:0] as a control clock signal CA_CLK.

In operation S23, the memory device, for example, the ECC decoder circuit 320 of FIG. 3, may perform error correction decoding on the control information and determine whether the error correction decoding passes.

If the error correction decoding fails (“No” in operation S23), the memory device, for example, the control circuit 330 of FIG. 3, may ignore the command CMD in operation S24.

If the error correction decoding is passed (“Yes” in operation S23), the control circuit 330 may determine whether the command CMD is a status read command in operation S25.

If the command CMD is not a status read command (“No” in operation S25), the control circuit 330 may ignore the command CMD in operation S24. For example, the control circuit 330 may discard the command without executing the operation indicated by the command CMD.

If the command CMD is a status read command (“Yes” in operation S25), the control circuit 330 may output fail data through the memory interface circuit 310 as a response to the status read command in operation S26.

In some example implementations, the fail data may include a fail flag value. In some example implementations, the fail data may further include failure information generated in operation S16 described with reference to FIG. 4.

In operation S27, the control circuit 330 may reset the fail flag.

FIG. 9 is a timing diagram of a control signal and a fail flag signal according to some example implementations.

Referring to FIG. 9, the memory device may transmit and receive control signals CA[X:0] and a control clock signal CA_CLK with a memory controller. In addition, the memory device may generate a fail flag.

In the example of FIG. 9, a first period T41, a second period T42, and a third period T43 are illustrated in time order.

In a state where the fail flag is set, the memory device may receive a status read command (Status read CMD) in the first period T41. For example, the memory device may sequentially receive a command header CMD_H, a command CMD, a parity header PAR_H, and a parity PAR in a first period T41. The memory device may obtain the command CMD and the parity PAR based on the headers CMD_H and PAR_H, and perform error correction decoding of the command using the parity PAR after the first period T41.

If the error correction decoding of the control signal received in the first period T41 fails, or if the command included in the control signal is not a status read command, the memory device may ignore the command. However, if the error correction decoding succeeds and the command is a status read command, the memory device may provide a response to the status read command to the memory controller in a second period T42.

According to some example implementations, a memory device, for example, a control circuit 330 described with reference to FIG. 3, may output a response to a status read command via a control signal line transmitting control signals CA[X:0]. For example, the response may include status information (Status) and fail data (Fail_D). The status information may indicate a state of the memory device, for example, whether the memory device is busy or ready. The fail data (Fail_D) may include a set fail flag value and failure information.

However, the present disclosure is not limited thereto. For example, the control device 330 may include a fail flag value in a reserved bit of 8-bit status information (Status) transmitted in a unit period.

According to some example implementations, the memory device may transmit fail data via the first pins P11 described with reference to FIG. 3. For example, the control signal line may support bidirectional communication between the memory controller and the memory device. The memory device may output control signals CA[X:0] including responses through the first pins P11 and simultaneously output a control clock signal CA_CLK through the second pin P12.

Accordingly, the memory device may notify the memory device of whether or not there is a failure and the failure information through the first pins P11 without adding a separate signal pin for fail alert, so that excessive design changes of the memory device are not required and the area occupied by the signal pin may be reduced.

The memory device may reset the fail flag after the second period T42. If error correction decoding for the control signals CA[X:0] received after the fail flag is reset is successful, the memory device may execute the command included in the control signals CA[X:0].

For example, the memory device may sequentially receive a command header CMD_H, a command CMD, a parity header PAR_H, and a parity PAR in a third period T43. If the memory device succeeds in error correction decoding of the control signals CA[X:0] received in the third period T43, the memory device may perform the command CMD included in the control signals CA[X:0].

For example, the memory controller may determine which control information has failed based on the failure information received from the memory device, and may retransmit the control information in which the fail occurred to the memory device.

On the other hand, if a failure occurs in a control signal received by the memory device, there is a high possibility that a failure will also occur in a control signal received later. For example, if the timing of the control signals CA[X:0] and the control clock signal CA_CLK is misaligned, causing a failure in the control signal, there is a high possibility that a failure will also occur in a control signal received later.

In some example implementations, the memory controller may improve the timing margin of the control signals CA[X:0] by reducing the frequency of the control signals CA[X:0] and the control clock signal CA_CLK. However, if the frequency of the control signals CA[X:0] is reduced, the transmission period of the control signals CA[X:0] may be lengthened, and further, the input/output efficiency of the data signal may be reduced.

According to some example implementations, the memory controller may perform training of the control signal in response to a fail flag received from the memory device before retransmitting the control signal in which a failure has occurred. Training of the control signal may refer to an operation for improving a timing margin in a control signal bus. For example, the memory controller may delay the control clock signal CA_CLK so that the rising edge of the control clock signal CA_CLK is located in the middle of an eye pattern of the control signal. For example, training of the control signal may be controlled by the processor 430 as described with reference to FIG. 3.

In some example implementations, the memory controller may start training by transmitting control signals CA[X:0] including a training command (Training CMD) including a command header CMD_H, a command CMD, a parity header PAR_H, and a parity PAR to the memory device in a third period T43. The memory controller may transmit a training command to the memory device, and then transmit a predetermined signal to the memory device through a control signal line, receive a response to the predetermined signal from the memory device through the control signal line, and control the delay of the control clock signal CA_CLK based on the response.

In some example implementations, the memory controller, for example, the processor 430 of FIG. 3, may control the second frequency of the control signals CA[X:0] and the control clock signal CA_CLK transmitted in the third period T43 to be lower than the first frequency of the control signals CA[X:0] and the control clock signal CA_CLK transmitted in the first and second periods T41 and T42. In the example of FIG. 9, the second cycle CY2 of the control clock signal CA_CLK transmitted in the third period T43 may be longer than the first cycle CY1 of the control clock signal CA_CLK transmitted in the first and second periods T41 and T42.

In the case of lowering the second frequency, even if the timing is misaligned, the timing margin may increase and the possibility that the training command will be successfully transmitted to the memory device may increase. Once the training command is successfully transmitted, the processor 430 may restore the second frequency to the first frequency and perform training.

Meanwhile, after the control signal fails, the status read command transmitted to the memory device may also fail. If the memory device does not normally receive the status read command, it may be difficult for the memory device to transmit the failure information.

According to some example implementations, the memory controller may detect a state in which the memory device does not normally receive a status read command, reduce the frequency of a control signal and a control clock signal, and obtain failure information by retransmitting the status read command.

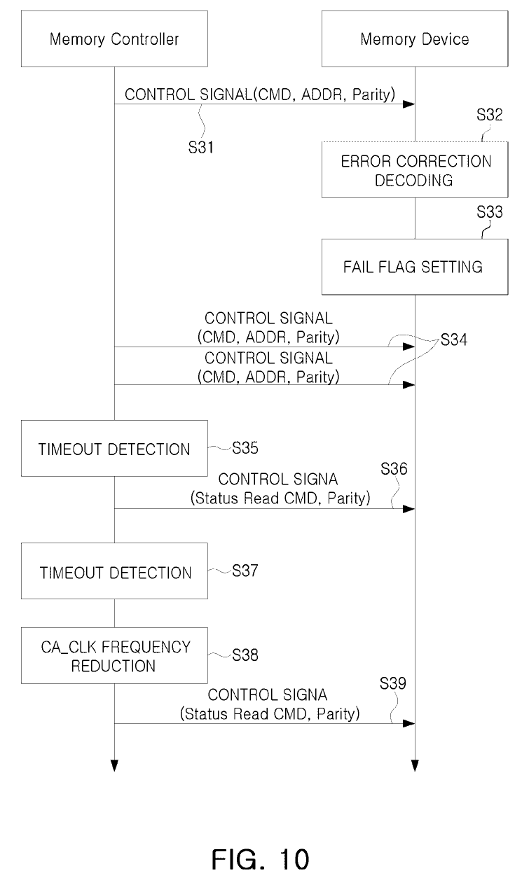

FIG. 10 is a diagram illustrating the interaction of a memory controller and a memory device according to some example implementations.

The memory device of FIG. 10 may correspond to the memory device 300 described with reference to FIG. 3, and the memory controller of FIG. 10 may correspond to the memory controller 400 described with reference to FIG. 3.

In operation S31, the memory controller may transmit control signals to the memory device. The control signals may be transmitted in parallel through a control signal line, which is a signal line different from data signals. According to some example implementations, the control signals may include at least a command CMD and a parity of the command. Control signals may include a command CMD, an address ADDR, and parity of the command and address.

In operation S32, the memory device may receive the control signal through the control signal line and perform error correction decoding. For example, the memory device may detect and correct an error of the command CMD and the address ADDR using the parity included in the control signal.

If the error correction of at least one of the command CMD and the address ADDR fails, the memory device may set a fail flag and store failure information in operation S33. Then, the memory device may ignore the control signal received in operation S31.

Even if the fail flag is set in the memory device, the memory controller may not detect whether a failure has occurred in the memory device until the failure information is transmitted to the memory controller.

In operation S34, the memory controller may transmit the control signals to the memory device. The memory device may perform error correction decoding of the control signals, but may ignore the control signal if the error correction decoding fails or if the command that succeeded in the error correction decoding is not a status read command.

In operation S35, the memory controller may detect a state in which there is no response to the control signal transmitted in operation S31 and the control signals transmitted thereafter. For example, the memory controller may detect a timeout state in which a response is not received even after a predetermined period of time after transmitting a certain control signal.

In operation S36, the memory controller may transmit a control signal including a status read command and parity to the memory device. If the memory device normally receives the status read command, the memory device may transmit fail data to the memory controller as a response to the status read command. However, if error correction decoding based on the control signal fails, the memory device may ignore the control signal.

In operation S37, the memory controller, for example, the processor 430 of FIG. 3, may detect a timeout state after transmitting the control signal including the status read command.

In operation S38, the processor 430 may reduce the frequency of the control signal and the control clock signal. In addition, in operation S39, the processor 430 may retransmit a control signal including the status read command to the memory device.

If the memory device normally receives the status read command, the memory device may transmit fail data to the memory controller as a response to the status read command, as described with reference to FIGS. 8 and 9.

As set forth above, according to some example implementations, a memory device may detect a command, an address, and a parity from a control signal received from a memory controller, and may perform error detection and correction of the command and address using the parity. Therefore, even if the transmission speed of the control signal received from the memory controller increases, the failure rate of the command may be reduced.

According to some example implementations, a memory device may output failure information of a control signal through the control signal input/output pin in response to a status read command received through a control signal input/output pin. Therefore, failure information may be provided to the memory controller without a design change that adds a separate input/output pin.

According to some example implementations, a memory controller may perform training on a control signal in response to failure information received through a control signal input/output pin to recover a failure of a control signal line and reduce the failure rate of the command.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While example implementations have been illustrated and described above, it will be apparent to those skilled in the art that modifications and variations could be made without departing from the scope of the present disclosure as defined by the appended claims.

What is claimed is:

1. A memory device comprising:
at least one first pin;
a plurality of second pins;
a memory interface circuit configured to obtain control information from at least one control signal received from the at least one first pin, obtain data from a plurality of data signals received from the plurality of second pins, and obtain a command and parity information from the control information by interpreting headers included in the control information;
a memory cell array configured to store the data;
an error correction code (ECC) decoder circuit configured to correct an error of the command, using the parity information, to generate an error-corrected command; and
a control circuit configured to control the memory device based on the error-corrected command in a reset state of a fail flag.

2. The memory device of claim 1, wherein the control circuit is configured to place the fail flag in a set state based on an error correction of the command failing.

3. The memory device of claim 2, wherein, based on the fail flag being placed in the set state, the control circuit is configured to ignore a command for which the error correction has failed, and ignore the error-corrected command based on the error-corrected command comprising a command different from a status read command.

4. The memory device of claim 2, wherein the control circuit is configured to, based on the fail flag being placed in the set state, generate status information including the fail flag in response to a status read command, and
the memory interface circuit is configured to output at least one additional control signal including the status information through the at least one first pin.

5. The memory device of claim 1, wherein the memory interface circuit is configured to obtain an address from the control information based on the headers,
the ECC decoder circuit is configured to generate an error-corrected address by correcting an error of the address using the parity information, and
the control circuit is configured to use the error-corrected address to control the memory cell array.

6. The memory device of claim 5, wherein the control circuit is configured to set the fail flag based on an error correction of at least one of the command and the address failing.

7. The memory device of claim 6, wherein, based on the fail flag being placed in the set state, the memory interface circuit is configured to generate failure information indicating a command or an address that has failed error correction, and output, based on a status read command, a response including the failure information through the at least one first pin.

8. The memory device of claim 7, wherein the control circuit is configured to reset the fail flag after the failure information is output.

9. The memory device of claim 1, wherein a frequency of the at least one control signal is lower than a frequency of the plurality of data signals.

10. A memory controller comprising:
at least one first pin;
a plurality of second pins;
a processor configured to generate a command for controlling a memory device;
a first error correction code (ECC) circuit configured to perform error correction encoding on the command to generate first parity information; and
a controller interface circuit configured to provide at least one control signal including the command and the first parity information to the memory device through the at least one first pin, input and output data signals to and from the memory device through the plurality of second pins, receive a fail signal indicating failure of the at least one control signal from the memory device, and perform training on the at least one control signal based on the fail signal.

11. The memory controller of claim 10, wherein the processor is configured to
provide, through the at least one first pin, a status read command to the memory device after the at least one control signal is output, and
receive, through the at least one first pin, the fail signal based on the status read command.

12. The memory controller of claim 11, wherein the processor is configured to change a frequency of a signal output to the at least one first pin from a first frequency to a second frequency based on a response to the status read command being received beyond a predetermined period of time, wherein the second frequency is lower than the first frequency, and retransmit a status read command to the memory device through the at least one first pin.

13. The memory controller of claim 10, wherein the processor is configured to, based on the failure information and completion of the training, retransmit a failed command through the at least one first pin.

14. The memory controller of claim 10, comprising a third pin configured to output a first clock signal,
wherein the processor is configured to change a frequency of the at least one control signal and the first clock signal from a first frequency to a second frequency that is lower than the first frequency, provide a training command to the memory device through the at least one first pin, perform training by changing the frequency of the at least one control signal and the first clock signal from the second frequency to the first frequency based on a first response of the memory device to the training command, transmit a predetermined signal to the memory device through the at least one first pin, receive a second response to the predetermined signal from the memory device through the at least one first pin, and control a delay of the first clock signal based on the second response.

15. The memory controller of claim 10, wherein the processor is configured to generate an address associated with the command,
the first ECC circuit is configured to generate second parity information by performing error correction encoding on the address, and
the at least one control signal includes the address and the second parity information.

16. The memory controller of claim 10, comprising a second ECC circuit configured to perform error correction encoding and error correction decoding on data included in the data signals.

17. A method of operating a memory device, comprising:
receiving at least one control signal including a command, an address, and parity information from a controller through at least one control signal line;
performing error correction code (ECC) decoding of the command and the address using the parity information;
setting a fail flag and generating failure information based on failure of an error correction of at least one of the command and the address;
providing a response including the failure information through the at least one control signal line in response to a status read command from the controller and resetting the fail flag; and
receiving a training command from the controller and providing a response through the at least one control signal line.

18. The method of claim 17, comprising ignoring a command other than the status read command while the fail flag is set.

19. The method of claim 17, wherein the parity information includes first parity information for the command and second parity information for the address, and
the failure information includes information indicating error correction failure of a command or an address.

20. The method of claim 17, comprising obtaining the command, the address, and the parity information based on a plurality of headers included in the at least one control signal.
